(19) United States
(12) Patent Application Publication
(10) Pub. No.: US 2023/0149247 A1
(43) Pub. Date: May 18, 2023

(54) PART FASTENING STRUCTURE AND MOUNTING TOOL

(71) Applicant: TOYOTA JIDOSHA KABUSHIKI KAISHA, Toyota-shi (JP)

(72) Inventor: Yoshinori FUJIKAKE, Nagakute-shi (JP)

(73) Assignee: TOYOTA JIDOSHA KABUSHIKI KAISHA, Toyota-shi (JP)

(21) Appl. No.: 17/958,510

(22) Filed: Oct. 3, 2022

(30) Foreign Application Priority Data
Nov. 12, 2021 (JP) 2021-185074

(51) Int. Cl. A61H 3/00

(52) U.S. Cl. CPC A61H 3/00; A61H 2201/165; A61H 2205/106; A61H 2201/0192

(57) ABSTRACT

A part fastening structure according to the present embodiment is a part fastening structure that fastens a part by using a bolt and a nut. The bolt is provided on a peripheral surface of a shaft portion, and includes a recess portion recessed to a central axis side and a thread groove provided on a head portion side of the recess portion. The nut includes a first nut member that is screwed into the thread groove, and a second nut member that is disposed on an outer peripheral side of the first nut member. The first nut member is provided with a lever that rotates around a rotation shaft extending in a direction parallel to an axial direction of the bolt.

### CROSS-REFERENCE TO RELATED APPLICATION

This application claims priority to Japanese Patent Application No. 2021-185074 filed on Nov. 12, 2021, incorporated herein by reference in its entirety.

### BACKGROUND

### 1. Technical Field

The present disclosure relates to a part fastening structure and a mounting tool.

### 2. Description of Related Art

Japanese Unexamined Patent Application Publication No. 2017-35220 (JP 2017-35220 A) discloses a walking training device including a walking assisting device attached to a trainee's leg. The walking assist device includes a thigh frame and a lower leg frame. The thigh frame is attached to the trainee's thigh and the lower leg frame is attached to the trainee's lower leg.

### SUMMARY

In such a walking training device, various trainees wear walking assist devices (also referred to as leg braces or mounting tools) for training. Thus, it is necessary for an assistant to adjust the walking assist device according to the trainee. For example, the assistant adjusts a frame length according to a length of a trainee's leg. In such a case, a part fastening structure for fastening two parts (for example, an upper frame and a lower frame) is used. That is, a frame is formed by fastening the two parts with the part fastening structure.

The frame length can be adjusted by the assistant loosening bolts and nuts and removing the two parts. That is, the assistant adjusts the frame length according to the leg length by changing the fastening position of the parts. Thus, it is desirable to easily and reliably attach and remove the parts. For example, it is desirable to attach and detach without a special tool. Further, a structure that does not loosen during use is desired.

The present disclosure has been made to solve such a problem, and provides a part fastening structure capable of simply and reliably fastening parts.

The part fastening structure in the present embodiment is a part fastening structure that fastens a part using a bolt and a nut. The bolt includes: a shaft portion extending along a central axis; a head portion protruding to an outer side from the shaft portion; a recess portion that is provided on a peripheral surface of the shaft portion and that is recessed to the central axis side; and a thread groove that is provided on the peripheral surface of the shaft portion, on the head portion side of the recess portion, in which the nut includes: a first nut member that is screwed with the thread groove; a second nut member that is disposed on an outer peripheral side of the first nut member; and a first urging member that is disposed between the first nut member and the second nut member and that urges the second nut member toward the head portion, in which the first nut member is provided with a lever that rotates around a rotation shaft extending in a direction parallel to an axial direction of the bolt, in which a protruding portion is provided on one end side of the lever, in which a second urging member that urges the lever is provided such that the protruding portion is inserted into the recess portion, in which the second nut member includes: a cylindrical portion having a hollow portion in which the first nut member is disposed; an accommodation port that accommodates the lever such that another end side of the lever is passed to an outer peripheral side of the cylindrical portion; and a knob that protrudes toward the outer peripheral side of the cylindrical portion.

In the part fastening structure described above, a plurality of the recess portions may be provided on the peripheral surface such that the recess portions are spaced away from each other in a circumferential direction.

In the part fastening structure described above, a first pin hole may be provided on an outer peripheral surface of the first nut member, a second pin hole that reaches an inner peripheral surface of the cylindrical portion from the outer side may be provided in the cylindrical portion of the second nut member, and the first nut member may be held by the second nut member by a pin inserted into the first pin hole through the second pin hole.

In the part fastening structure described above, the first pin hole may be an elongated hole in which a longitudinal direction coincides with the axial direction.

A mounting tool according to the present embodiment is a mounting tool that is worn by a user, the mounting tool including: a first part including a plurality of first through holes; a second part including a second through hole; and the part fastening structure described above, in which the bolt is inserted through the first through hole and the second through hole.

According to the present disclosure, it is possible to provide a part fastening structure and a mounting tool capable of simply and reliably fastening parts.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a front view showing two parts fastened by a part fastening structure;

FIG. 2 is a side view showing the two parts fastened by the part fastening structure;

FIG. 3 is a bottom view of the part fastening structure;

FIG. 4 is a perspective view showing a configuration of the part fastening structure;

FIG. 5 is an exploded perspective view showing the configuration of the part fastening structure;

FIG. 6 is a cross-sectional view of the part fastening structure cut along a plane orthogonal to a central axis;

FIG. 7 is a cross-sectional view of the part fastening structure cut along the plane orthogonal to the central axis;

FIG. 8 is a cross-sectional view for describing an operation of the part fastening structure at the time of fastening;

FIG. 9 is a cross-sectional view for describing the operation of the part fastening structure at the time of fastening;

FIG. 10 is a cross-sectional view for describing the operation of the part fastening structure at the time of fastening; and

FIG. 11 is a schematic perspective view showing a mounting tool having the part fastening structure.

### DETAILED DESCRIPTION OF EMBODIMENTS

Hereinafter, the present disclosure will be described through embodiments of the disclosure. However, the disclosure according to the claims is not limited to the following embodiments. Moreover, all of the configurations described in the embodiments are not necessarily indispensable as means for solving the issue.

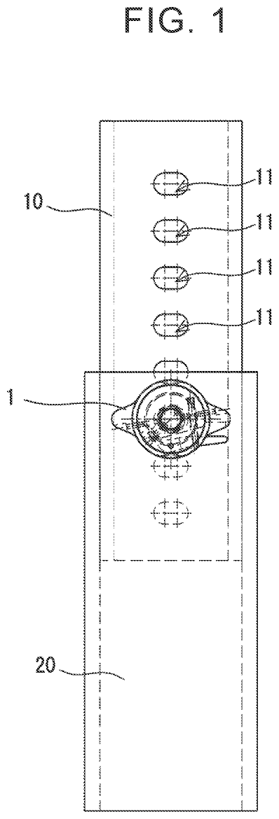

A part fastening structure 1 for fastening a first part 10 and a second part 20 will be described with reference to FIGS. 1 to 3. The first part 10 and the second part 20 configure, for example, a frame to be attached to a leg of a trainee who performs walking training. Here, the first part 10 and the second part 20 are fastened by the part fastening structure 1 to form a frame disposed along a lower leg of the trainee. An assistant (also called a user) who assists the trainee adjusts the length of the frame according to the trainee.

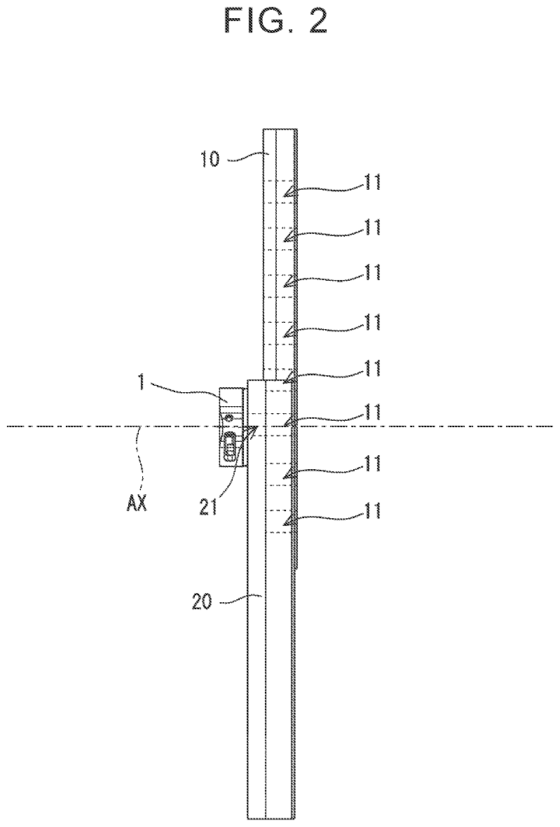

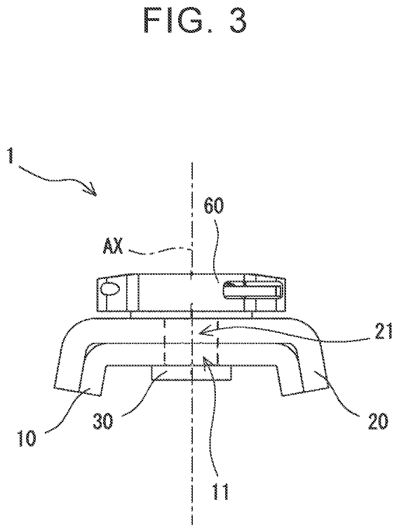

FIG. 1 is a front view showing parts fastened by the part fastening structure 1 and FIG. 2 is a side view showing the parts fastened by the part fastening structure 1. FIG. 3 is a bottom view of the part fastening structure 1.

One of the first part 10 and the second part 20 is disposed on an upper side, and the other is disposed on a lower side. Here, the first part 10 is disposed on a knee side and the second part 20 is disposed on an ankle side. The part fastening structure 1 is disposed laterally to a shin. Of course, the first part 10 and the second part 20 are not limited to the lower leg frame and the leg brace. Further, the vertical arrangement of the first part 10 and the second part 20 is not particularly limited.

As shown in FIG. 3, the part fastening structure 1 includes a bolt 30 and a nut 60. In the part fastening structure 1, the first part 10 and the second part 20 are fastened using the bolt 30 and the nut 60. The bolt 30 is passed through through holes provided in the first part 10 and the second part 20. In FIG. 3 and the like, a straight line along an axis center of the bolt 30 is shown as a central axis AX. The bolt 30 and the nut 60 are attached by rotating the bolt 30 or the nut 60 around the central axis AX. By attaching the nut 60 to the bolt 30, the first part 10 and the second part 20 are fastened.

The first part 10 and the second part 20 are members whose longitudinal direction is along the lower leg. In FIG. 1, the first part 10 and the second part 20 are both channel steels. For example, the first part 10 and the second part 20 are each made of a metal material such as aluminum. A direction along the central axis AX is a thickness direction of the first part 10 and the second part 20.

As shown in FIGS. 1 and 2, the first part 10 is provided with a plurality of through holes 11. The through hole 11 extends through in the thickness direction of the first part 10. The through holes 11 are disposed in one row along the longitudinal direction of the first part 10. Here, the through holes 11 are formed at equal intervals along the longitudinal direction of the first part 10. Each of the through holes 11 has an elongated hole shape to suppress rotation on the bolt side. The through holes 11 have the same size and the same shape.

The second part 20 includes one through hole 21. The through hole 21 extends through the second part 20 in a thickness direction of the second part 20. The first part 10 and the second part 20 are disposed so as to partially overlap each other. The first part 10 and the second part 20 are disposed so that the through hole 21 of the second part 20 overlaps with one through hole 11 of the first part 10. The bolt 30 is inserted into the through hole 21 of the second part 20 and the through hole 11 of the first part 10. Then, the nut 60 is attached to the bolt 30 inserted into the through hole 11 and the through hole 21. As a result, the first part 10 and the second part 20 are fixed. Here, the bolt 30 is in contact with the first part 10 and the nut 60 is in contact with the second part 20.

Further, by changing the through hole 11 into which the bolt 30 is inserted, a length of an overlapping portion of the first part 10 and the second part 20 is changed. Thus, the total length of the frame can be adjusted. For example, by inserting the bolt 30 into the through hole 11 on the lower side of FIGS. 1 and 2 among the through holes 11, the overlapping portion of the first part 10 and the second part 20 is shortened. Thus, the frame length can be increased. By inserting the bolt 30 into the through hole 11 on the upper side of FIGS. 1 and 2 among the through holes 11, the overlapping portion of the first part 10 and the second part 20 becomes longer. Thus, the frame length can be shortened. In this way, the frame length can be made variable by changing the fastening position by the part fastening structure 1.

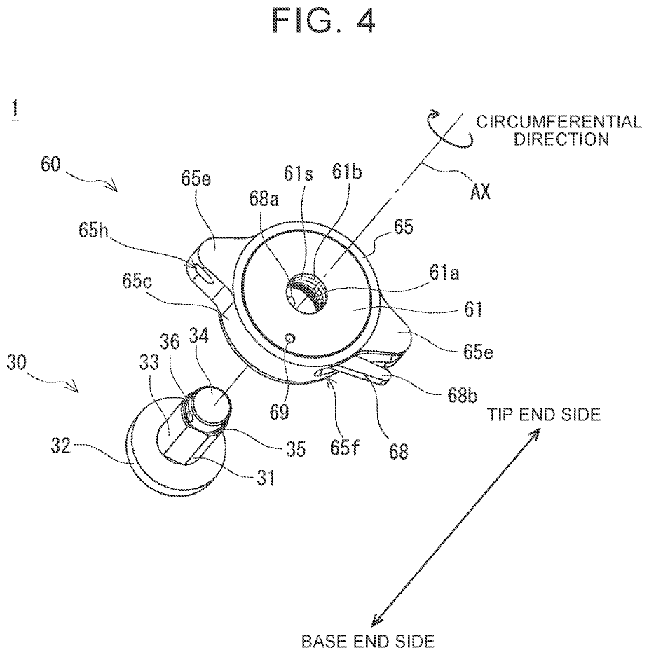

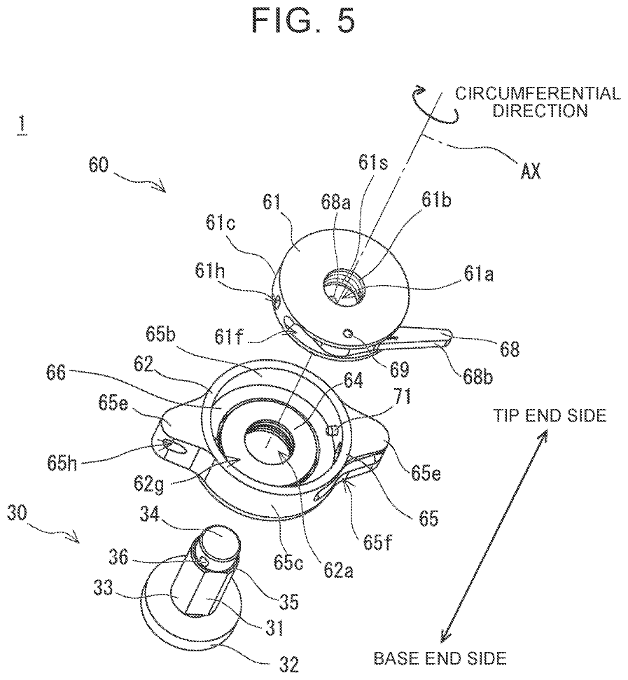

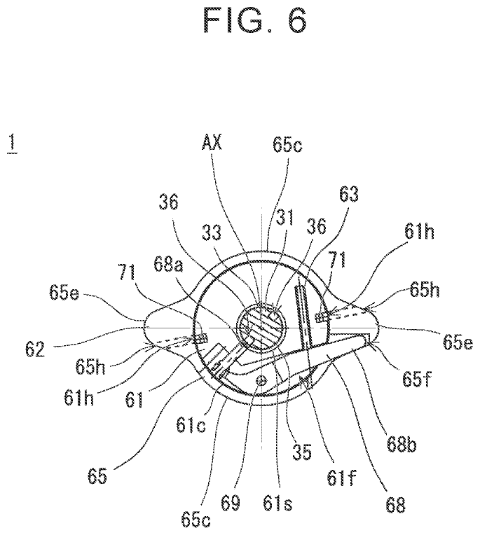

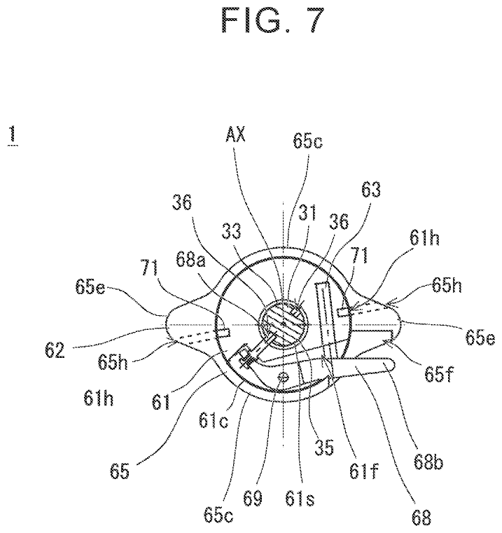

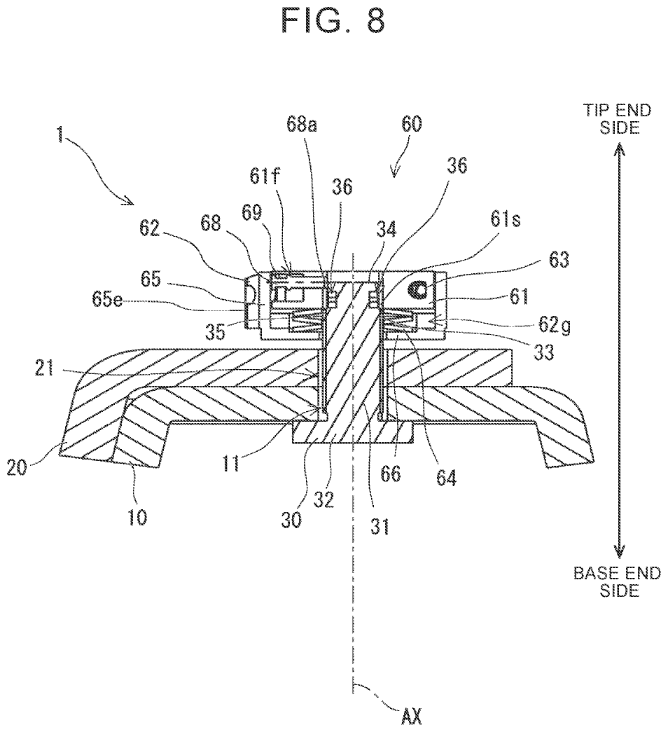

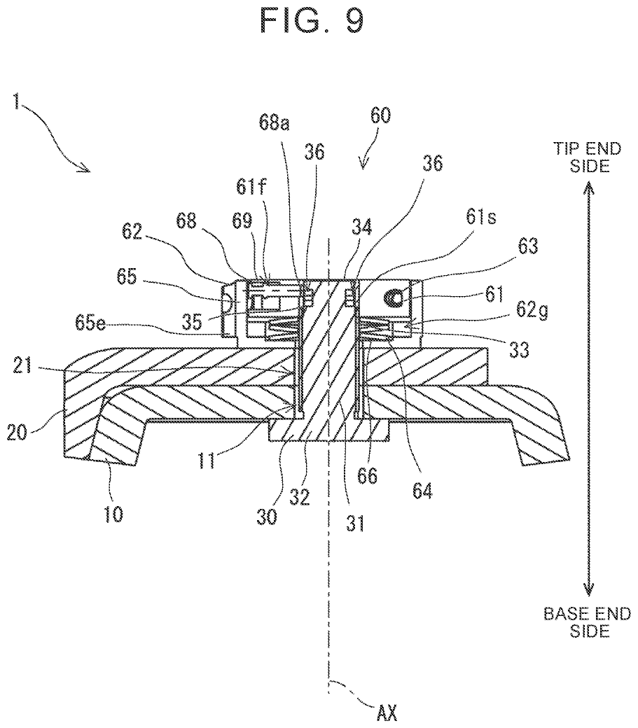

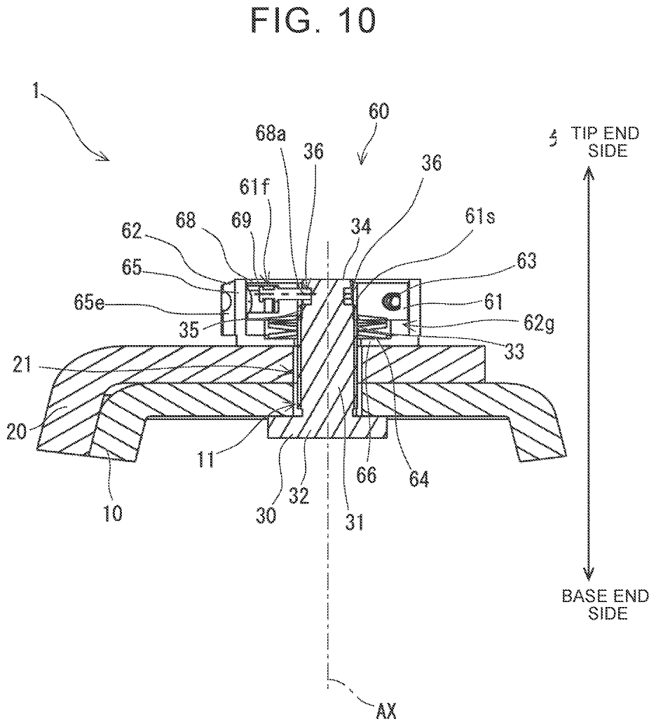

Next, the part fastening structure 1 will be described with reference to FIGS. 4 to 10. FIG. 4 is a perspective view showing the part fastening structure 1 in a state before the bolt 30 and the nut 60 are attached. FIG. 5 is an exploded perspective view of the part fastening structure 1. FIGS. 6 and 7 are diagrams for explaining an operation of an internal structure of the nut 60. Specifically, FIG. 6 shows a state during fastening, and FIG. 7 shows a state after fastening. FIGS. 8 to 10 are cross-sectional views for describing the operation of the part fastening structure. FIG. 8 shows the operation of the part fastening structure at the time when the fastening is started, and FIG. 10 shows the operation of the part fastening structure at the time when the fastening is completed. FIG. 9 shows the process of fastening between FIGS. 8 and 10.

First, the configuration of the bolt 30 will be described with reference to FIGS. 4, 5, and the like. The bolt 30 includes a shaft portion 31 and a head portion 32. The bolt 30 is made of a metal material such as iron.

The shaft portion 31 is a substantially columnar portion, and is a portion inserted into the through hole 11 shown in FIG. 1 or the like. In FIGS. 4 and 5, the center of the shaft portion 31 is defined as the central axis AX. A direction parallel to the central axis AX of the shaft portion 31 is defined as an axial direction. The axial direction is the direction in which the bolt 30 is inserted into the through hole 11. Further, as shown in FIGS. 4, 5, and the like, a direction around the central axis AX is defined as a circumferential direction. Thus, like a cylindrical coordinate system, a position in the circumferential direction is represented by an angle of 0 to 360° with a reference position (origin position) as 0°. As shown in FIG. 5, the head portion 32 side in the axial direction is a base end side, and the opposite side is a tip end side.

The shaft portion 31 includes a tip end surface 34 and a peripheral surface 33. The tip end surface 34 corresponds to a bottom surface of a cylinder, and the peripheral surface corresponds to a side surface of the cylinder. The tip end surface 34 is provided on the tip end side of the shaft portion 31. The tip end surface 34 is the bottom surface located on the tip end side of the columnar shaft portion 31. The tip end surface 34 is a plane orthogonal to the central axis AX.

The head portion 32 is provided on the base end side of the shaft portion 31. The head portion 32 is a disc-shaped dish portion. An outer diameter of the head portion 32 is larger than an outer diameter of the shaft portion 31. The outer diameter of the shaft portion 31 is smaller than the through holes 11 and 21 so as to be inserted into the through holes 11 and 21. The outer diameter of the head portion 32 is larger than that of the through holes 11 and 21. Therefore, the head portion 32 comes into contact with the first part 10. A washer, a disc spring, or the like may be disposed between the head portion 32 and the first part 10.

The peripheral surface 33 is a portion from the tip end surface 34 to the head portion 32. That is, the peripheral surface 33 is a side surface (outer peripheral surface) of the shaft portion 31 having a substantially columnar shape. A thread groove 35 and a recess portion 36 are formed on the peripheral surface 33. The recess portion 36 is provided on the tip end side of the thread groove 35. In the axial direction, the recess portion 36 is disposed between the tip end surface 34 and the thread groove 35. The thread groove 35 is formed in a spiral shape on the peripheral surface 33. The thread groove 35 is provided on the head portion 32 side of the bolt 30 with respect to the recess portion 36.

The recess portion 36 is a recess provided on the peripheral surface 33. The recess portion 36 is recessed toward the central axis AX side. The recess portion 36 is larger than a pitch of the thread groove 35 and is formed deeper than the thread groove 35. As will be described later, a tip end portion 68a of a lever 68 is inserted into the recess portion 36. The peripheral surface 33 is provided with two recess portions 36. The recess portions 36 are provided at two points on the peripheral surface 33. In the circumferential direction, the two recess portions 36 are provided apart from each other. Specifically, assuming that the position of one recess portion 36 in the circumferential direction is 0°, the position of the other recess portion 36 in the circumferential direction is 180°. That is, the two recess portions 36 are disposed symmetrically with respect to the central axis AX. In the axial direction, the positions of the two recess portions 36 may be the same or different.

Next, the configuration of the nut 60 will be described with reference to FIGS. 4 to 7. The nut 60 includes a first nut member 61, a second nut member 62, and a disc spring 64. Further, the nut 60 includes a spring 63 and the lever 68. The spring 63 and the lever 68 are attached to the second nut member 62. The first nut member 61 and the lever 68 are made of a metal material such as iron. The second nut member 62 is made of a metal material such as aluminum.

The first nut member 61 is a cylindrical member or a ring-shaped member. That is, the first nut member 61 is a member having a hollow portion 61a provided along the central axis AX. The hollow portion 61a is a columnar space along the axial direction. The shaft portion 31 is inserted into the hollow portion 61a. The first nut member 61 is screwed into the thread groove 35.

The surface of the first nut member 61 on the hollow portion 61a side is defined as an inner peripheral surface 61b. The outer peripheral surface of the first nut member 61 is referred to as an outer peripheral surface 61c. The shaft portion 31 of the bolt 30 is inserted into the hollow portion 61a. A thread groove 61s is formed on the inner peripheral surface 61b. The thread groove 61s is screwed with the thread groove 35 of the bolt 30. The thread groove 61s is provided on the entire inner peripheral surface 61b.

With the thread groove 35 of the bolt 30 and the thread groove 61s of the nut 60 meshing with each other, the user rotates the bolt 30 or the nut 60 in the circumferential direction. By doing so, the relative position of the bolt 30 with respect to the nut 60 changes in the axial direction. For example, the user can tighten or loosen the bolt 30 and the nut 60 by rotating the nut 60 in the circumferential direction.

As shown in FIG. 5 and the like, a pin hole 61h into which a pin 71 is inserted is formed on the outer peripheral surface 61c of the first nut member 61. Here, the pin hole 61h does not have to reach the inner peripheral surface 61b. That is, the pin hole 61h may be a recess provided in the outer peripheral surface 61c. The pin hole 61h may be a through hole that reaches the inner peripheral surface 61b from the outer peripheral surface 61c.

As shown in FIG. 6 and the like, the pin holes 61h are provided at two locations on the outer peripheral surface 61c. In the circumferential direction, the two pin holes 61h are disposed apart from each other. The two pin holes 61h are disposed symmetrically with respect to the central axis AX. Each pin hole 61h has an elongated hole shape with the axial direction as the longitudinal direction. As will be described later, the size of the pin hole 61h in the longitudinal direction defines the amount of movement of the first nut member 61 with respect to the second nut member 62.

Further, the first nut member 61 is provided with an accommodation portion 61f for accommodating the lever 68 and the spring 63. The accommodation portion 61f is a recess provided on the outer peripheral surface 61c. The lever 68 and the spring 63 are accommodated in the accommodation portion 61f Further, the accommodation portion 61f reaches from the outer peripheral surface 61c to the inner peripheral surface 61b. That is, the tip end portion 68a of the lever 68 is a protruding portion protruding from the inner peripheral surface 61b toward the hollow portion 61a. An operation portion 68b of the lever 68 is disposed outside an outer peripheral surface 65c of the second nut member 62.

The lever 68 is rotatably attached to the first nut member 61 via a rotation shaft 69. For example, the lever 68 is provided with a through hole for the rotation shaft 69 to pass through. The rotation shaft 69 extends through the lever 68. The rotation shaft 69 is attached to the first nut member 61. As a result, the lever 68 rotates around the rotation shaft 69. The rotation shaft 69 is disposed along the direction parallel to the central axis AX. In a plan view orthogonal to the central axis AX, the rotation shaft 69 is at a position deviated from the central axis AX. The side opposite to the tip end portion 68a of the lever 68 is set as the operation portion 68b. The operation portion 68b is a portion protruding from the first nut member 61 in a plan view orthogonal to the central axis AX. That is, in the state shown in FIG. 7, the portion outside the outer peripheral surface 61c is the operation portion 68b.

The rotation shaft 69 is disposed in the accommodation portion 61f. The lever 68 is disposed along the plane orthogonal to the central axis AX. The rotation shaft 69 is disposed between the operation portion 68b and the tip end portion 68a in the longitudinal direction of the lever 68. That is, the tip end portion 68a is provided on one end side of the lever 68, and the operation portion 68b is provided on the other end side of the lever 68.

For example, in FIG. 7, the tip end portion 68a is disposed on a left side of the rotation shaft 69, and the operation portion 68b is disposed on a right side of the rotation shaft 69. When the user operates the operation portion 68b, the lever 68 rotates. As the lever 68 rotates around the rotation shaft 69, the position of the tip end portion 68a changes. The rotation operation of the lever 68 will be described later.

As shown in FIGS. 5 and 6, the spring 63 is attached to the lever 68. The spring 63 urges the lever 68 so that the lever 68 rotates. For example, the accommodation portion 61f has a cylindrical recess portion and accommodates the spring 63 as shown in FIG. 7. One end of the spring 63 abuts on the lever 68 and the other end abuts on the first nut member 61. The spring 63 urges the operation portion 68b side of the lever 68 so that the lever 68 rotates about the rotation shaft. An expansion/contraction direction of the spring 63 is, for example, parallel to the plane orthogonal to the central axis AX. The spring 63 is contracted more than its natural length in the state shown in FIG. 7. In FIG. 7, the spring 63 urges the lever 68 in the direction in which the lever 68 rotates clockwise.

The spring 63 is, for example, a coil spring. In the present embodiment, the spring 63 has a diameter of 2 mm, a natural length of 15 mm, and a spring constant of 0.5 N/mm. A mounting length in the state shown in FIG. 7 is 12.5 mm, and a mounting load is 1.25 N. In the state shown in FIG. 6, it is in the most contracted state, and its spring length is 10 mm. A maximum load in the state shown in FIG. 6 is 2.5N. The spring 63 is a second urging member that generates an urging force for rotating the lever 68. Of course, the urging member is not limited to the spring 63, and an elastic body such as resin may be used.

Next, the second nut member 62 will be described. The second nut member 62 is a case for accommodating the first nut member 61. As shown in FIG. 5, the second nut member 62 includes a hollow portion 62a into which the shaft portion 31 is inserted.

The second nut member 62 includes a cylindrical portion 65 and a bottom portion 66. The cylindrical portion 65 is a cylindrical or ring-shaped portion. An inner surface of the cylindrical portion 65 is an inner peripheral surface 65b, and an outer surface is the outer peripheral surface 65c. The inner peripheral surface 65b is a surface facing the outer peripheral surface 61c of the first nut member 61. In a plan view orthogonal to the central axis AX, the diameter of the inner peripheral surface 65b is larger than the diameter of the outer peripheral surface 61c. Thus, the first nut member 61 is housed inside the cylindrical portion 65.

The bottom portion 66 is disposed on the base end side of the cylindrical portion 65, that is, the end portion on the head portion 32 side. The bottom portion 66 has a disc shape parallel to the plane orthogonal to the central axis AX. The bottom portion 66 has a disc shape in which the hollow portion 62a is vacant. In the axial direction, the bottom portion 66 is disposed between the head portion 32 and the first nut member 61. The hollow portion 62a, the hollow portion 61a, the cylindrical portion 65, and the shaft portion 31 are concentric in a plan view orthogonal to the central axis AX. That is, the centers of the hollow portion 62a, the hollow portion 61a, and the cylindrical portion 65 coincide with the central axis AX.

The side opposite to the bottom portion 66 of the cylindrical portion 65, that is, the tip end side is open. Then, the first nut member 61 is housed in the second nut member 62 from the tip end side of the cylindrical portion 65. The first nut member 61 is disposed in a cylindrical space 62g defined by the cylindrical portion 65 and the bottom portion 66.

The disc spring 64 is disposed between the bottom portion 66 and the first nut member 61 in the axial direction. The disc spring 64 generates an urging force in the direction in which the first nut member 61 and the bottom portion 66 of the second nut member 62 are separated from each other. The disc spring 64 urges the second nut member 62 to the base end side, that is, to the head portion 32 side. The disc spring 64 urges the first nut member 61 toward the tip end side. In the axial direction, the disc spring 64 becomes the first urging member that generates an urging force between the first nut member 61 and the second nut member 62. The amount of expansion and contraction of the disc spring 64 is defined by the axial size of the pin hole 61h. That is, a spring length of the disc spring 64 has a stroke corresponding to the size of the pin hole 61h in the axial direction.

The cylindrical portion 65 is provided with two knobs 65e. The knobs 65e are portions of the cylindrical portion 65 protruding outward from the outer peripheral surface 65c. That is, the knobs 65e are portions extending in a direction away from the central axis AX from the outer peripheral surface 65c of the cylindrical portion 65. The two knobs 65e are disposed so as to face each other with the central axis AX interposed therebetween. The user can rotate the nut 60 in the circumferential direction by operating the two knobs 65e. By providing the second nut member 62 with the knobs 65e protruding outward from the cylindrical portion 65, the user can easily rotate the nut 60.

Further, the cylindrical portion 65 is provided with an accommodation port 65f for accommodating the lever 68. The accommodation port 65f is a space that reaches the inner peripheral surface 65b from the outer peripheral surface 65c. Further, the accommodation port 65f is formed from the cylindrical portion 65 to the knob 65e. That is, a space serving as an accommodation port 65f is formed in the knob 65e and the cylindrical portion 65.

Each knob 65e is provided with a pin hole 65h. The pin hole 65h extends through from the outer peripheral side of the knob 65e through the cylindrical portion 65 to the inner peripheral surface 65b. As shown in FIG. 6, in a plan view orthogonal to the central axis AX, the pin hole 65h is a through hole extending through the second nut member 62. In a plan view orthogonal to the central axis AX, the two pin holes 65h are disposed so as to face each other with the central axis AX therebetween. For example, the two pin holes 65h pass through the central axis AX and are disposed on a straight line orthogonal to the central axis AX. The pin hole 65h is formed so as to be connected to the pin hole 61h of the first nut member 61.

Then, as shown in FIGS. 6 and 7, the pin 71 is inserted into the pin hole 65h and the pin hole 61h from the outside. The pin 71 reaches the pin hole 61h from the outside of the knob 65e via the pin hole 65h. The pin 71 projects from the inner peripheral surface 65b toward the central axis AX. Thus, since the tip of the pin 71 is inserted into the pin hole 61h, the second nut member 62 and the first nut member 61 cannot be removed.

In this way, the first nut member 61 is attached to the second nut member 62. When the pin 71 is inserted into the pin hole 61h, the second nut member 62 holds the first nut member 61. It is possible to suppress the first nut member 61 from coming off from the second nut member 62. Further, the pin hole 61h is an elongated hole in which the longitudinal direction is the axial direction. Thus, the first nut member 61 moves relative to the second nut member 62 along the axial direction.

An operation of the lever will be described with reference to FIGS. 6 and 7. FIGS. 6 and 7 are diagrams schematically showing a cross-sectional structure in which the part fastening structure 1 is cut along a plane orthogonal to the axial direction. FIGS. 6 and 7 show states in which rotation angles of the lever 68 around the rotation shaft 69 are different. FIG. 6 shows a state during fastening, and FIG. 7 shows a state after fastening. A rotation position shown in FIG. 6 is a movable position, and a rotation position shown in FIG. 7 is a fixed position.

In FIGS. 6 and 7, the spring 63 urges the lever 68 in the direction in which the lever 68 rotates clockwise. That is, the spring 63 generates an urging force in the direction in which the tip end portion 68a of the lever 68 approaches the central axis AX. In other words, the spring 63 generates an urging force in the direction in which the operation portion 68b of the lever 68 protrudes from the accommodation port 65f.

In the movable position shown in FIG. 6, the tip end portion 68a of the lever 68 is not inserted into the recess portion 36. Specifically, the axial positions of the tip end portion 68a and the recess portion 36 are deviated from each other. Since the tip end portion 68a is in contact with the peripheral surface 33, the tip end portion 68a cannot move to the central axis AX side. In FIG. 6, the bolt 30 and the nut 60 are in a state where they can be rotated. This state is referred to as a movable state. In the movable state, the rotation between the bolt 30 and the nut 60 is not restricted.

When the recess portion 36 and the tip end portion 68a are misaligned, the tip end portion 68a is in contact with the peripheral surface 33. The peripheral surface 33 regulates the rotation of the lever 68. Thus, the rotation angle of the lever 68 is constant. When the user rotates the nut 60, the tip end portion 68a moves relative to the peripheral surface 33. When the nut 60 is rotated, the tip end portion 68a moves spirally on the peripheral surface 33. Thus, the bolt 30 and the nut 60 can be relatively moved in the axial direction without the user having to operate the lever 68. By rotating the bolt 30 and the nut 60, the positions in the axial direction are displaced. Thus, the bolt 30 can be removed from the nut 60 by rotating the bolt 30 or the nut 60 in the circumferential direction. Alternatively, the bolt 30 can be attached to the nut 60 by rotating the bolt 30 or the nut 60 in the circumferential direction.

At the fixed position shown in FIG. 7, the tip end portion 68a of the lever 68 is inserted into the recess portion 36. Thus, the bolt 30 cannot be rotated with respect to the nut 60. This state is defined as a fixed state. In the fixed state, rotation between the bolt 30 and the nut 60 is restricted.

Specifically, the spring 63 urges the lever 68 in the direction in which the tip end portion 68a approaches the central axis AX. When the positions of the recess portion 36 and the tip end portion 68a match, the tip end portion 68a is inserted into the recess portion 36. That is, the lever 68 rotates around the rotation shaft 69, and the tip end portion 68a moves toward the central axis AX side with respect to the peripheral surface 33. In FIG. 7, the rotation of the lever 68 is restricted by the lever 68 coming into contact with the cylindrical portion 65 at the accommodation port 65f.

When the tip end portion 68a is fitted into the recess portion 36, the rotational operation of the nut 60 and the bolt 30 is restricted. Thus, unless the user operates the lever 68, the bolt 30 and the nut 60 cannot be rotated. That is, the bolt 30 and the nut 60 cannot be rotated unless the user rotates the lever 68 in the direction opposite to the urging force of the spring 63. In the state where the tip end portion 68a is in the recess portion 36 in this way, the rotation of the bolt 30 and the nut 60 is restricted. That is, the nut 60 is fixed to the bolt 30 in a fixed state.

Further, in order to rotate the bolt 30 and the nut 60, the user pushes the operation portion 68b so that the lever 68 is accommodated in the accommodation portion 61f and the accommodation port 65f. Then, as shown in FIG. 6, when the lever 68 is accommodated, the tip end portion 68a is taken out from the recess portion 36. As a result, the part fastening structure 1 is in a movable state in which the rotation restriction is released, and the bolt 30 and the nut 60 can rotate.

The operation at the time of fastening will be described in detail with reference to FIGS. 8 to 10. FIGS. 8 to 10 are cross-sectional views showing the structure of the part fastening structure 1 for fastening the first part 10 and the second part 20. FIGS. 8 to 10 are cross-sectional views of the part fastening structure 1 cut along a plane including the central axis AX. FIGS. 8 and 9 show a movable state in which the tip end portion 68a is not inserted into the recess portion 36. FIG. 10 shows a fixed state in which the tip end portion 68a is inserted into the recess portion 36.

FIG. 8 is a cross-sectional view at a position where the thread groove 35 of the bolt 30 and the thread groove 61s of the nut 60 start meshing (hereinafter referred to as a meshing start position). FIG. 10 is a cross-sectional view at a position where the fastening of the bolt 30 and the nut 60 is completed (hereinafter referred to as a fastening completed position). FIG. 9 is a cross-sectional view showing a configuration at a position between the meshing start position and the fastening completion position. Specifically, FIG. 9 shows the position where the second nut member 62 is in contact with the second part 20.

When the shaft portion 31 of the bolt 30 is inserted into the hollow portions 61a and 62a along the axial direction from the state where the bolt 30 and the nut 60 are not attached (see FIG. 4), the bolt 30 and the nut 60 are in the meshing start position shown in FIG. 8. The thread groove 35 and the thread groove 61s come into contact with each other. The tip end side of the thread groove 35 and the base end side of the thread groove 61s mesh with each other. In this state, the tip end portion 68a comes into contact with the peripheral surface 33. In the state shown in FIG. 8, the second part 20 and the second nut member 62 are separated from each other in the axial direction.

When the shaft portion 31 of the bolt 30 is inserted into the hollow portions 61a and 62a along the axial direction, the user operates the lever 68 so as to cancel the urging force of the spring 63 until the tip end portion 68a is in contact with the peripheral surface 33. That is, the user pushes the lever 68 toward the accommodation port 65f until the thread groove 35 and the thread groove 61s mesh with each other. By doing so, the tip end portion 68a is located outside the peripheral surface 33 in a plan view orthogonal to the central axis AX. When the tip end portion 68a comes into contact with the peripheral surface 33, the tip end portion 68a receives the reaction force of the urging force of the spring 63 from the peripheral surface 33. Thus, the user may release the lever 68 after the thread groove 35 and the thread groove 61s are meshed with each other.

When the nut 60 is rotated in a tightening direction from the position shown in FIG. 8, it becomes as shown in FIG. 9. In FIG. 9, the nut 60 is seated on the second part 20. That is, the bottom portion 66 of the second nut member 62 and the second part 20 come into contact with each other. The relative displacement amount in the axial direction due to the rotation of the nut 60 between FIGS. 8 and 9 is 1.3 mm. That is, in the state shown in FIG. 9, the nut 60 approaches the first part 10 by 1.3 mm from the state shown in FIG. 8 in the axial direction.

In the state up to FIG. 9, since the peripheral surface 33 and the tip end portion 68a are in contact with each other, the tip end portion 68a is not in the recess portion 36. The tip end portion 68a receives a reaction force of the urging force of the spring 63 from the peripheral surface 33. Thus, the user can rotate the nut 60 without operating the lever 68.

Further, in the axial direction, the disc spring 64 generates an urging force between the first nut member 61 and the second nut member 62. That is, the disc spring 64 urges the first nut member 61 toward the tip end side and the second nut member 62 toward the base end side. From the state of FIG. 8 to the state shown in FIG. 9, the expansion and contraction amount of the disc spring 64 is zero (natural length).

When the nut 60 is further rotated in the tightening direction from the position shown in FIG. 9, it becomes as shown in FIG. 10. The relative displacement amount in the axial direction due to the rotation of the nut 60 between FIGS. 9 and 10 is 0.7 mm.

In FIG. 10, the tip end portion 68a is disposed in the recess portion 36. In this state, as shown in FIG. 7, the lever 68 protrudes from the accommodation portion 61f and the accommodation port 65f As described above, the rotation of the bolt 30 and the nut 60 is restricted. In other words, the fastening of the bolt 30 and the nut 60 is maintained unless the user pushes in the lever 68. It is possible to suppress the bolt 30 from coming off from the nut 60. Thus, the first part 10 and the second part 20 can be securely fastened.

When removing the first part 10 and the second part 20, the user operates the lever 68 from the states shown in FIGS. 7 and 10. That is, the user pushes the lever 68 toward the accommodation portion 61f As a result, the lever 68 rotates counterclockwise in FIG. 6, and the tip end portion 68a moves to the outside of the recess portion 36. Thus, the restriction on the rotation of the bolt 30 and the nut 60 is lifted. With the lever 68 pushed in, the user rotates the nut 60 in the loosening direction. By doing so, the nut 60 is removed from the bolt 30, so that the first part 10 and the second part 20 can be removed.

As described above, in the present embodiment, the nut 60 includes the first nut member 61, the second nut member 62, the spring 63, and the lever 68. When the user pushes the spring 63, the lever 68 rotates, so that the bolt 30 and the nut 60 can be attached and detached. The user can easily and surely fasten the first part 10 and the second part 20.

Further, the user can remove the bolt 30 and the nut 60 by just lever operation and rotating the nut 60. Thus, simple attachment and detachment is possible. No special tools are required for installation and removal. That is, attachment and detachment can be performed with the user's own hand or finger. Further, durability and workability can be improved.

In other words, unless the user pushes in the lever 68, the bolt 30 will not come off the nut 60. As a result, the bolt 30 and the nut 60 can be securely fixed. Loosening of the bolt 30 can be suppressed, and the two parts can be securely fastened. That is, it is possible to suppress the bolt 30 from coming off from the nut 60 when the parts are fastened.

Further, when the nut 60 is further rotated from the position shown in FIG. 9 in the direction of tightening further, the disc spring 64 contracts. In the axial direction, the size of the pin hole 61h in the longitudinal direction ensures the displacement amount (stroke) of the pin 71 in the pin hole 61h. That is, within the size of the pin hole 61h, the axial distance between the bottom portion 66 and the first nut member 61 changes. Further, the distance between the first nut member 61 and the second nut member 62 in the axial direction changes according to the amount of expansion and contraction of the disc spring 64.

Further, as the disc spring 64 contracts, the urging force between the first nut member 61 and the second nut member 62 becomes stronger. Thus, after the nut 60 comes into contact with the second part 20, the disc spring 64 contracts when the nut 60 is rotated in the tightening direction. The more the nut 60 is rotated in the tightening direction, the stronger the force required to rotate the nut 60.

Thus, in the present embodiment, the two recess portions 36 are disposed apart from each other in the circumferential direction on the peripheral surface 33. This makes it possible to suppress the force for rotating the nut 60 from increasing. In the present embodiment, the two recess portions 36 are disposed 180° apart in the circumferential direction. The rotation angle of the nut 60 from the height at which the tip end portion 68a fits in the recess portion 36 to the rotation angle of the nut 60 until the axial positions of the recess portion 36 and the tip end portion 68a match can be made less than 180°. On the other hand, when only one recess portion 36 is provided on the peripheral surface 33, the rotation angle of the nut 60 until the axial positions of the recess portion 36 and the tip end portion 68a match is a maximum of 360°. Therefore, by forming the two or more recess portions 36 apart in the circumferential direction, it is possible to suppress the force for rotating the nut 60 from increasing.

A method of attaching the first nut member 61 to the second nut member 62 will be described with reference to FIG. 5. First, the user attaches the lever 68 to the accommodation portion 61f in a state where the spring 63 is accommodated in the accommodation portion 61f. Then, the user attaches the lever 68 to the first nut member 61 by using the rotation shaft 69. As a result, the first nut member 61 as shown in FIG. 5 can be prepared.

Next, the user attaches the first nut member 61 having the lever 68 to the second nut member 62. Specifically, with the first nut member 61 tilted with respect to the axial direction, the operation portion 68b is passed through the accommodation port 65f from the inner peripheral surface 65b side. The user passes the operation portion 68b of the lever 68 from the inner peripheral surface 65b side to the outer peripheral surface 65c side. The user matches the circumferential direction of the pin hole 61h and the pin hole 65h. Then, the pin 71 is press-fitted into the pin hole 65h so as to be caught in the pin hole 61h. As a result, since the first nut member 61 is attached to the second nut member 62, the nut 60 shown in FIG. 4 is formed.

Further, by making the pin hole 61h a through hole, the first nut member 61 can be removed from the second nut member 62. Specifically, by pushing the pin 71 toward the central axis AX, the pin 71 protrudes from the inner peripheral surface 61b. Thus, the pin 71 can be removed from the hollow portion 61a. By removing the two pins 71, the first nut member 61 can be taken out from the second nut member 62.

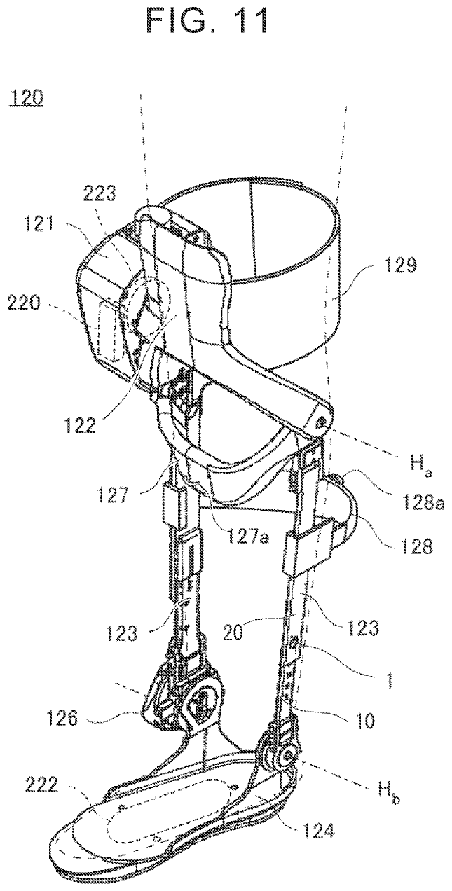

FIG. 11 is a diagram showing an example of a mounting tool using the part fastening structure 1. FIG. 11 is a perspective view schematically showing a mounting tool 120 worn by the user. The mounting tool 120 mainly includes a control unit 121, a plurality of frames that support each part of the affected leg, and a load sensor 222 for detecting a load applied to the sole of the foot. The mounting tool 120 functions as a walking assist device having a drive unit and a control unit.

The control unit 121 includes an auxiliary control unit 220 that controls the mounting tool 120, and also includes a motor (not shown) that generates a driving force for assisting the extension movement and the flexion movement of the knee joint. The frame supporting each part of the affected leg includes a thigh frame 122 and a lower leg frame 123 rotatably connected to the thigh frame 122. Further, this frame includes a foot flat frame 124 rotatably connected to the lower leg frame 123, a front side connecting frame 127, and a rear side connecting frame 128.

The thigh frame 122 and the lower leg frame 123 rotate relative to each other around a hinge axis Hₐ shown in the figure. The motor of the control unit 121 rotates in accordance with an instruction of the auxiliary control unit 220 to assist the thigh frame 122 and the lower leg frame 123 to open or close relatively around the hinge axis Hₐ. An angle sensor 223 housed in the control unit 121 is, for example, a rotary encoder, and detects an angle formed by the thigh frame 122 and the lower leg frame 123 around the hinge axis Hₐ. The lower leg frame 123 and the foot flat frame 124 rotate relative to each other around the hinge axis H_{b} shown in the figure. The relative rotating angle range is pre-adjusted by the adjusting mechanism 126.

The thigh frame 122 includes a thigh belt 129. The thigh belt 129 is a belt integrally provided on the thigh frame, and is wrapped around the thigh portion of the affected leg to fix the thigh frame 122 to the thigh portion. This suppresses the entire mounting tool 120 from shifting with respect to the trainee's legs.

The load sensor 222 is a load sensor embedded in the foot flat frame 124. The load sensor 222 can also be configured to detect the magnitude and distribution of the vertical load received by the trainee's sole, for example, to detect a center of pressure (COP). The load sensor 222 is, for example, a resistance change detection type load detection sheet in which electrodes are disposed in a matrix.

The lower leg frame 123 includes the first part 10 and the second part 20 shown in FIG. 1. Then, the first part 10 and the second part 20 are connected via the part fastening structure 1. That is, the user attaches the first part 10 and the second part 20 by the part fastening structure 1. Thus, the length of the lower leg frame 123 can be adjusted in accordance with the leg length of the user who wears the mounting tool 120. The user can easily and surely fasten the first part 10 and the second part 20 of the lower leg frame 123. Therefore, the user can easily adjust the frame length. The number of parts to be fastened by the part fastening structure 1 may be 3 or more.

Although the disclosure made by the present inventor has been specifically described above based on the embodiment, the present disclosure is not limited to the above embodiment and can be variously modified within a range that does not depart from the gist thereof.

What is claimed is:

1. A part fastening structure that fastens a part using a bolt and a nut,
wherein the bolt includes:
a shaft portion extending along a central axis;
a head portion protruding to an outer side from the shaft portion;
a recess portion that is provided on a peripheral surface of the shaft portion and that is recessed to the central axis side; and
a thread groove that is provided on the peripheral surface of the shaft portion, on the head portion side of the recess portion,
wherein the nut includes:
a first nut member that is screwed with the thread groove;
a second nut member that is disposed on an outer peripheral side of the first nut member; and
a first urging member that is disposed between the first nut member and the second nut member and that urges the second nut member toward the head portion,
wherein the first nut member is provided with a lever that rotates around a rotation shaft extending in a direction parallel to an axial direction of the bolt,
wherein a protruding portion is provided on one end side of the lever,
wherein a second urging member that urges the lever is provided such that the protruding portion is inserted into the recess portion,
wherein the second nut member includes:
a cylindrical portion having a hollow portion in which the first nut member is disposed;
an accommodation port that accommodates the lever such that another end side of the lever is passed to an outer peripheral side of the cylindrical portion; and
a knob that protrudes toward the outer peripheral side of the cylindrical portion.

2. The part fastening structure according to claim 1, wherein a plurality of the recess portions is provided on the peripheral surface such that the recess portions are spaced away from each other in a circumferential direction.

3. The part fastening structure according to claim 1,
wherein a first pin hole is provided on an outer peripheral surface of the first nut member,
wherein a second pin hole that reaches an inner peripheral surface of the cylindrical portion from the outer side is provided in the cylindrical portion of the second nut member, and
wherein the first nut member is held by the second nut member by a pin inserted into the first pin hole through the second pin hole.

4. The part fastening structure according to claim 3, wherein the first pin hole is an elongated hole in which a longitudinal direction coincides with the axial direction.

5. A mounting tool that is worn by a user, the mounting tool comprising:
a first part including a plurality of first through holes;
a second part including a second through hole; and
the part fastening structure according to claim 1,
wherein the bolt is inserted through the first through hole and the second through hole.
